(19) United States
(12) Patent Application Publication
(10) Pub. No.: US 2026/0230846 A1
(43) Pub. Date: Aug. 6, 2026

(54) MITIGATING INTER-CELL INTERFERENCE FROM UNCONTROLLED SOURCES

(71) Applicant: T-MOBILE INNOVATOINS LLC, Overland Park, KS (US)

(72) Inventor: Chaitanya CHUKKA, Plainfield, IL (US)

(21) Appl. No.: 19/045,326

(22) Filed: Feb. 4, 2025

(51) Int. Cl. H04W 24/02; H04B 17/309; H04L 41/5009; H04W 24/10

(52) U.S. Cl. CPC H04W 24/02; H04B 17/346; H04L 41/5009; H04W 24/10

(57) ABSTRACT

Embodiments of the present disclosure are directed to mitigating inter-cell interference between public and private Radio Access Networks (RANs) using licensed spectrum. It describes a network environment with public and private base stations and user equipment (UE) experiencing interference. Mitigation procedures, such as reducing transmission power, beamforming, and deactivating cells, are implemented based on the geographic and frequency relationship between public and private cells.

### SUMMARY

The present disclosure is directed to mitigating inter-cell interference, substantially as shown and/or described in connection with at least one of the Figures, and as set forth more completely in the claims.

According to various aspects of the technology, inter-cell interference is mitigated between a source that is controlled by a mobile network operator (MNO), such as a first base station of a public radio access network (RAN), and an source that is not controlled by the MNO, such as a second base station of a private RAN. 5G private networks are specialized cellular networks designed to serve the communication needs of specific organizations, such as enterprises, factories, hospitals, or campuses. Unlike public 5G networks, which are operated by telecom carriers and provide broad, consumer-focused coverage, private 5G networks are tailored to offer secure, reliable, and high-performance connectivity within a confined geographic area. Private 5G networks may be permanent or temporary and enable advanced applications with greater control over network parameters like latency, bandwidth, and security. Despite their advantages, private 5G networks often use licensed spectrum, leading to inter-cell interference between different RANs using the same or similar frequencies, which can cause poor connections for UEs. Neighboring 5G private networks (or a private 5G network that neighbors a public network) manage spectrum conflicts through coordinated, uncoordinated, and brokered approaches; however, these approaches become increasingly inadequate as the number and density of private 5G networks grow, leading to more frequent spectrum contention and the need for more sophisticated real-time interference management solutions. The present disclosure is directed to mitigating inter-cell interference, particularly between public and private RANs. When a cell of a public RAN and a cell of a private RAN transmit signals using frequencies that cause interference, a UE in the vicinity of both networks may observe key performance indicator (KPI) degradation. The public RAN may query a database of other public and private cells in the vicinity to identify the interfering private cell. Based on the geographic and frequency relationship between the public and private cells, the public cell operator may implement mitigation procedures such as reducing transmission power, beamforming, or deactivating cells. Additionally, the mitigation procedures can be reversed to return to normal operations once the interference condition is resolved, ensuring minimal disruption to long-term network performance.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Aspects of the present disclosure are described in detail herein with reference to the attached Figures, which are intended to be exemplary and non-limiting, wherein:

FIG. 1 illustrates a computing device for use with the present disclosure;

FIG. 2 illustrates a network environment in which implementations of the present disclosure may be employed;

FIGS. 3A-3B illustrate mitigation procedures based on varying network deployments for use with the present disclosure; and

FIG. 4 illustrates a flow diagram of a method in accordance with embodiments described herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32^{nd} Edition, 2022). As used herein, the terms “base station” or “access point” refer to a centralized component or system of components that is configured to wirelessly communicate (receive and/or transmit signals) with a plurality of stations (i.e., wireless communication devices, also referred to herein as user equipment (UE(s))) in a particular geographic area. As used herein, the term “network access technology (NAT)” is synonymous with wireless communication protocol and is an umbrella term used to refer to the particular technological standard/protocol that governs the communication between a UE and a base station; examples of network access technologies suitable for use with the present disclosure include but are not limited to 3G, 4G, 5G, 6G, 802.11x, and the like.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions - including data structures and program modules - in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, 5G private networks are specialized cellular networks designed to serve the communication needs of specific organizations, such as enterprises, factories, hospitals, or campuses. Unlike public 5G networks, which are operated by telecom carriers and provide broad, consumer-focused coverage, private 5G networks are tailored to offer secure, reliable, and high-performance connectivity within a confined geographic area. Private 5G networks may be permanent (e.g., installed at factories or hospitals) or temporary (e.g., a football stadium during games or during football season, or special events such as parades or music festivals). In addition to dedicated bandwidth, private 5G networks can enable advanced applications, such as industrial automation, IoT device connectivity, remote operations, and enhanced real-time communications, with greater control over network parameters like latency, bandwidth, and security—particularly when compared with Wi-Fi. One of the key advantages of private 5G is its ability to deliver significantly greater reliability, scalability, and coverage. Unlike Wi-Fi, which can struggle with interference and signal degradation in large or densely packed environments, private 5G networks (particularly those that use licensed or controlled spectrum), which reduces interference and ensures consistent performance even in challenging settings. This is particularly important for industries like manufacturing or logistics, where uninterrupted communication is critical for operational efficiency and safety. Private 5G networks also offer advanced security features, including built-in encryption, authentication, and the ability to control and monitor all network components within an organization's infrastructure. In contrast, Wi-Fi networks, especially in high-traffic or open environments, are more susceptible to hacking and unauthorized access. Despite the advantages, private 5G networks often use licensed spectrum, of which there is limited supply, and inter-cell interference between different RANs using the same (or similar) frequencies can cause UEs to have poor connections with either RAN. This problem is exacerbated by the fact that a public RAN operator, which has exclusive rights to a licensed spectrum, may grant a private RAN operator the right to use at least a portion of the licensed spectrum - but the public RAN has little or no control over the operation of the private RAN's base stations. That is, inter-cell interference between a public RAN and a private RAN (or between two private RANs) cannot be easily controlled or mitigated by the spectrum license holder (the public RAN operator).

Conventionally, neighboring 5G private networks (or a private 5G network that neighbors a public network) manage spectrum conflicts through one or more techniques, including coordinated, uncoordinated, and brokered approaches. Coordinated spectrum sharing involves active communication between networks, often facilitated by a centralized system like a Spectrum Access System (SAS), to dynamically allocate spectrum and minimize interference. Uncoordinated spectrum sharing relies on decentralized mechanisms where networks independently adjust power levels, frequency hopping, or listen-before-talk techniques to reduce conflicts without centralized oversight. Brokered spectrum sharing uses an intermediary to allocate spectrum dynamically based on demand, priority, or leasing arrangements, balancing competing network needs.

While conventional approaches mitigate interference to some extent, they become increasingly inadequate as the number and density of private 5G networks grow, leading to more frequent spectrum contention, unpredictable performance, and the need for more sophisticated real-time interference management solutions to ensure reliable and fair spectrum access. Coordinated spectrum sharing requires extensive infrastructure, regulatory oversight, and participation compliance, which can be difficult in fragmented or competitive environments. Uncoordinated spectrum sharing risks inefficient spectrum use and higher interference due to the lack of global optimization across networks. Brokered spectrum sharing, while more structured, may introduce additional costs, administrative complexity, and delays in spectrum allocation that hinder real-time adaptability.

Unlike conventional solutions, the present disclosure is directed to mitigating inter-cell interference, particularly between public and private RANs. In the event that a cell of a public RAN and a cell of a private RAN are configured to transmit signals using frequencies that cause interference to each other, a UE in the vicinity of both networks is likely to observe a degradation to one or more key performance indicators (KPIs). Based on the KPI degradation being reported to the public RAN, the public RAN may query a database of other public cells and private cells in the vicinity of the public RAN cell. Based on a return from the query indicating that a private RAN cell is operating in the geographic vicinity and frequency vicinity (i.e., the same frequencies, overlapping frequencies, adjacent frequencies, or nearby frequencies), the public RAN operator may attribute the KPI degradation to public-private inter-cell interference. Responsive to such an attribution, and based on the geographic relationship between the public and private cells, the public cell operator may implement one or more mitigation procedures. If the private cell extends a relatively small amount into the public cell, then the public cell may use a reduced transmission power or beamforming (e.g., codebook beamforming subset restrictions) to avoid the private cell; whereas, if the private cell extends a relatively large amount into the public cell, then the public cell may be de-activated.

Accordingly, a first aspect of the present disclosure is directed to a system for mitigating inter-cell interference. The system comprises a base station of a first radio access network (RAN) configured to wirelessly communicate with a user equipment (UE) in a first coverage area. The system further comprises one or more computer processing components configured to perform a series of operations. Said operations comprise determining a degradation in one or more key performance indicators (KPIs) of wireless telecommunication signals of a cell of the base station. Said operations further comprise determining the degradation is caused by an operation of a second RAN, the second RAN being different than the first RAN. Said operations further comprise determining a second coverage area of the second RAN at least partially overlaps with the first coverage area. Said operations further comprise implementing a mitigation action based on said determinations.

A second aspect of the present disclosure is directed to a method for mitigating inter-cell interference. The method comprises determining, based on a degradation of one or more key performance indicators (KPIs) of wireless telecommunication signals of a cell of a first base station, that an inter-cell interference condition exists between the first base station and a second base station. The method further comprises determining, based on a query to a networked data repository, that the second base station is associated with a second RAN, the second RAN being different than a first RAN associated with the first base station. The method further comprises determining, based on the query, a second coverage area associated with the second base station. The method further comprises determining, based on an amount of overlap of the first coverage area and the second coverage area, a mitigation action. The method further comprises implementing the mitigation action at the first base station, wherein the mitigation action modifies wireless signal propagation by the first base station.

Another aspect of the present disclosure is directed to a non-transitory computer readable media having instructions stored thereon that, when executed by one or more computer processing components, cause the one or more computer processing components to perform operations for mitigating method for radio resource allocation. The operations comprise determining, based on a degradation of one or more key performance indicators (KPIs) of wireless telecommunication signals of a cell of a first base station, that an inter-cell interference condition exists between the first base station and a second base station. The operations further comprise determining, based on a query to a networked data repository, that the second base station is associated with a second RAN, the second RAN being different than a first RAN associated with the first base station. The operations further comprise determining, based on the query, a second coverage area associated with the second base station. The operations further comprise determining, based on an amount of overlap of the first coverage area and the second coverage area, a mitigation action. The operations further comprise implementing the mitigation action at the first base station, wherein the mitigation action modifies wireless signal propagation by the first base station.

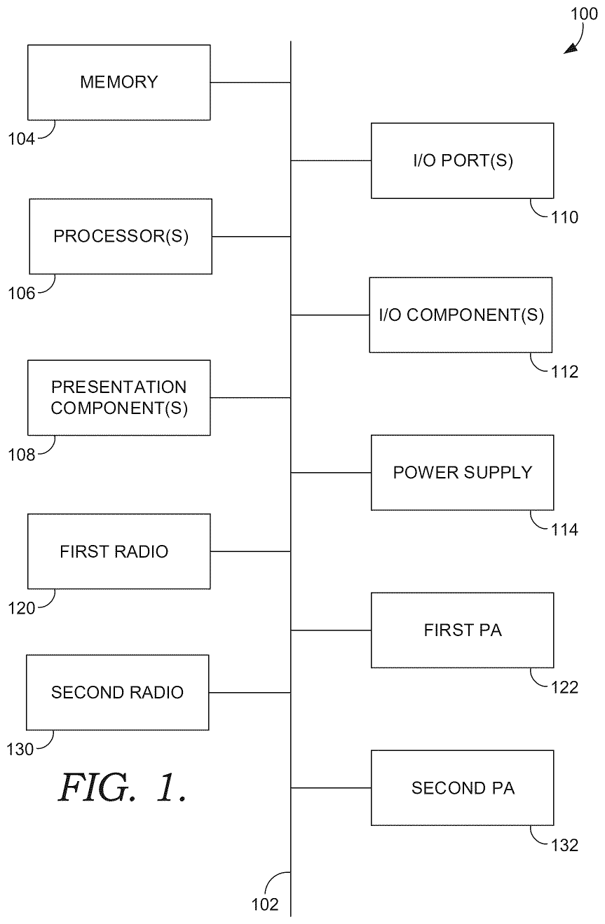

Referring to FIG. 1, an exemplary computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to an access point and receive one or more signals from the access point (or some other access point); the computing device 100 may be referred to herein as a user equipment, wireless communication device, or user device. The computing device 100 may take the form of a wireless access device that acts as a more localized and consolidated access point that provides end user wireless devices access to a broader network; examples of wireless access devices include fixed wireless access (FWA) devices and mobile hotspots. The computing device 100 may take the form of a mobile device, used herein to refer to categories of often-portable devices that utilize a wireless connection to a broader network and are typically configured for direct human interaction and personal computing tasks; examples of mobile devices include smartphones, tablets, extended reality (XR) device (e.g., augmented reality (AR), virtual reality (VR), and mixed reality (MR)), computers (e.g., laptops and PCs), wearable devices (e.g., smartwatches, fitness tracker), electronic readers (i.e., an e-book reader or digital book reader), portable media player, handheld GPS/location device, digital camera, gaming console, and digital voice recorders. The computing device may take the form of a connected vehicle that integrates advanced communication and computing technologies to interact with other devices and networks, encompassing vehicle to vehicle (V2V) communications, vehicle to infrastructure (V2I) communications, and/or vehicle to everything (V2X) communications, and that utilizes a wireless connection to support telematics, infotainment systems, over the air updates, vehicle health monitoring, and/or enhanced navigation; examples of connected vehicles include automotive, locomotive, airborne, and cargo (e.g., train car, semi-trailer) systems. The computing device 100 may take the form of an Internet of Things (IoT) device, a physical object embedded with sensors, software, or other technologies that enable them to collect, exchange, and act on data using an internet connection, which allows them to perform automated, decision-making or, other content-provision tasks; examples of IoT devices include smart home devices (e.g., smart thermostats, smart lights, power supply/management systems, and smart security systems), connected appliances (e.g., smart refrigerators), health monitoring devices (e.g., blood pressure monitor, glucose monitor), industrial devices (e.g., smart sensors, predictive maintenance systems), and agricultural devices (e.g., soil, environmental, or growth sensors).

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, input/output (I/O) ports 110, I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of I/O components 112. Also, processors, such as one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media of the computing device 100 may be in the form of a dedicated solid state memory or flash memory, such as a subscriber information module (SIM). Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, nonremovable, or a combination thereof. Exemplary memory includes solid-state memory, hard drives, optical-disc drives, etc. Computing device 100 includes one or more processors 106 that read data from various entities such as bus 102, memory 104 or I/O components 112. One or more presentation components 108 presents data indications to a person or other device. Exemplary one or more presentation components 108 include a display device, speaker, printing component, vibrating component, etc. I/O ports 110 allow computing device 100 to be logically coupled to other devices including I/O components 112, some of which may be built in computing device 100. Illustrative I/O components 112 include a microphone, joystick, game pad, satellite dish, scanner, printer, wireless device, etc.

A first radio 120 and a second radio 130 represent radios that facilitate communication with one or more wireless networks using one or more wireless links. In aspects, the first radio 120 utilizes a first transmitter 122 to communicate with a wireless network on a first wireless link and the second radio 130 utilizes the second transmitter 132 to communicate on a second wireless link. Though two radios are shown, it is expressly conceived that a computing device with a single radio (i.e., the first radio 120 or the second radio 130) could facilitate communication over one or more wireless links with one or more wireless networks via both the first transmitter 122 and the second transmitter 132. Illustrative wireless telecommunications technologies include CDMA, GPRS, TDMA, GSM, 802.11, and the like. One or both of the first radio 120 and the second radio 130 may carry wireless communication functions or operations using any number of desirable wireless communication protocols, including 802.11 (Wi-Fi), WiMAX, LTE, 3G, 4G, LTE, 5G, NR, VoLTE, or other VoIP communications. In aspects, the first radio 120 and the second radio 130 may be configured to communicate using the same protocol but in other aspects they may be configured to communicate using different protocols. In some embodiments, including those that both radios or both wireless links are configured for communicating using the same protocol, the first radio 120 and the second radio 130 may be configured to communicate on distinct frequencies or frequency bands (e.g., as part of a carrier aggregation scheme). As can be appreciated, in various embodiments, each of the first radio 120 and the second radio 130 can be configured to support multiple technologies and/or multiple frequencies; for example, the first radio 120 may be configured to communicate with a base station according to a cellular communication protocol (e.g., 4G, 5G, 6G, or the like), and the second radio 130 may be configured to communicate with one or more other computing devices according to a local area communication protocol (e.g., IEEE 802.11 series, Bluetooth, NFC, z-wave, or the like).

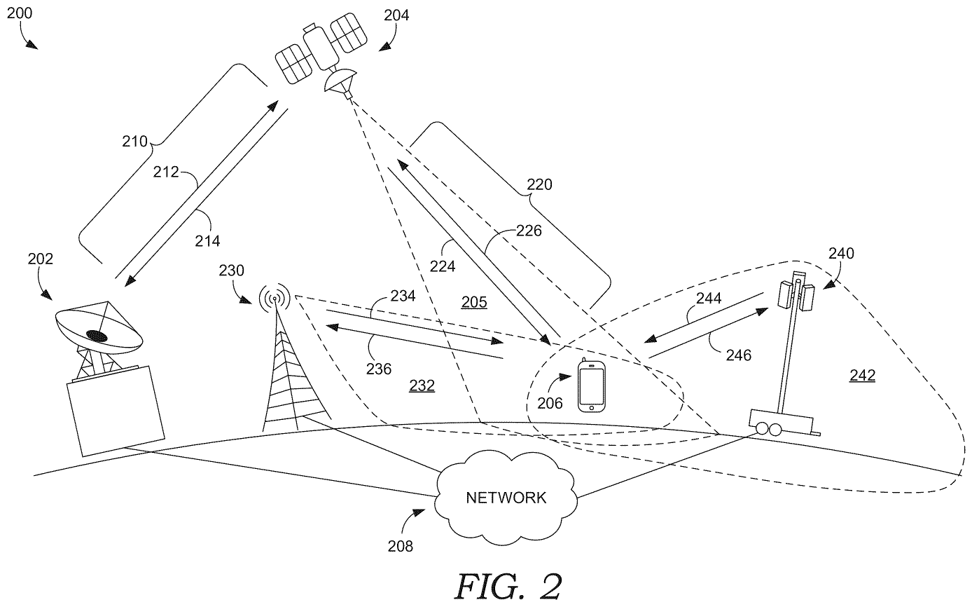

Turning now to FIG. 2, a representative network environment is illustrated in which implementations of the present disclosure may be employed. Such a network environment is illustrated and designated generally as network environment 200. At a high level the network environment 200 comprises a plurality of radio access networks (RANs), a UE 206, and a network 208. Each RAN of the plurality of RANs may take the form of a satellite RAN, which comprises at least a gateway 202 and a satellite 204, a first terrestrial RAN comprising at least a first base station 230, or a second terrestrial RAN comprising a second base station 240. Though three RANs are illustrated in the network environment 200, it is expressly conceived that the present disclosure may be suitable for use in an environment containing the second terrestrial RAN and at least one of the satellite RAN and the first terrestrial RAN. Though the composition of network environment 200 illustrates objects in the singular, it should be understood that more than one of each component is expressly conceived as being within the bounds of the present disclosure; for example, the network environment 200 may comprise multiple gateways, multiple distinct networks, multiple UEs, multiple satellites that communicate with a single gateway or multiple gateways, multiple satellites that may have inter-satellite links, multiple terrestrial base stations, and the like. Though certain objects of network environment 200 are illustrated in a certain form, it should also be understood that they may take other forms; for example, even though the UE 206 is illustrated as a cellular phone, a UE suitable for implementations with the present disclosure may be any computing device having any one or more aspects described with respect to FIG. 1, and even though the first base station 230 is illustrated as a macro cell mounted on a tower and the second base station 240 is illustrated as a mobile cell (i.e., a “cell on wheels”), terrestrial base stations suitable for use with the present disclosure is any terrestrial station configured to transmit signals to and receive signals from the UE 206 (e.g., fixed, mobile, a small cell, pico cell, relay, and the like).

In aspects where the RAN of the network environment 200 is a satellite RAN, the gateway 202 may be said to be communicatively connected to the network 208 and the satellite 204. The gateway 202 may be connected to the network 208 via one or more wireless or wired connections and is connected to the satellite 204 via a feeder link 210. The gateway 202 may take the form of a device or a system of components configured to communicate with the UE 206 via the satellite 204 and to provide an interface between the network 208 and the satellite 204. Generally, the gateway 202 utilizes one or more antennas to transmit signals to the satellite 204 via a forward uplink 212 and to receive signals from the satellite 204 via a return downlink 214. The gateway 202 may communicate with a plurality of satellites, including the satellite 204. The network 208 comprises any one or more public or private networks, any one or more of which may be configured as a satellite network, a publicly switched telephony network (PSTN), or a cellular telecommunications network. In aspects, the network 208 may comprise a satellite network connecting a plurality of gateways (including the gateway 202) to other networks, a cellular core network (e.g., a 4G, 5G, of 6G core network, an IMS network, and the like), and a data network. In such aspects, each of the satellite network and the cellular core network may be associated with a network identifier such as a public land mobile network (PLMN), a mobile country code, a mobile network code, or the like, wherein the network identifier associated with the satellite network is the same or different than the network identifier associated with the cellular network.

When present in the network environment 200, the satellite 204 is generally configured to provide wireless communication service to the UE 206. In aspects where the satellite 204 is a bent pipe type, the satellite 204 may primarily operate by relaying communications between the gateway 202 and the UE 206. In aspects where the satellite 204 is processing or regenerative type, the satellite 204 may handle at least some signal processing, routing, switching, and resource allocation/scheduling on board, while still using a connection to the gateway 202 as a backhaul to the network 208. The satellite 204 communicates with the gateway using the feeder link 210 and communicates with the UE 206 using a user link 220. The user link 220 comprises a forward downlink 224 used to communicate signals from the satellite 204 to the UE 206 and a return uplink 226 used to communicate signals from the UE 206 to the satellite 204. The satellite 204 may communicate with the UE 206 using any wireless telecommunication protocol desired by a network operator, including but not limited to 3G, 4G, 5G, 6G, 802.11x and the like. Though shown as having a single beam providing coverage to a satellite coverage area 222, the satellite 204 may be configured to utilize a plurality of individual beams to communicate with multiple different areas at or near the same time. Similarly, though a single forward downlink 224 and a single return uplink 226 are illustrated, the UE 206 may utilize multiple downlinks and/or multiple uplinks to communicate with the satellite 204, using any one or more frequencies as desired by a satellite or network operator.

Generally, the satellite 204 is characterized by its orbit around the earth. The orbit of any particular satellite will vary by operator desire and/or intended use; for example, a satellite suitable for use with the present disclosure may be characterized by its maximum orbital altitude and/or orbital period as Low Earth Orbit (LEO), Medium Earth Orbit (MEO), and High Earth Orbit (HEO)—also referred to herein as characterizing an orbital plane. Though not rigidly defined, an LEO satellite may orbit with a maximum orbital altitude of less than approximately 1,250 miles, an MEO satellite may orbit with a maximum orbital altitude generally between 1,250 and 22,000 miles, and an HEO satellite may orbit with a maximum orbital altitude of greater than approximately 22,000 miles. In some, but not all cases, a satellite in HEO may be considered geosynchronous (i.e., geosynchronous earth orbit (GEO)) on the basis that its orbital period is approximately equal to the length of a sidereal or solar day (approximately 24 hours); generally, a satellite in geosynchronous orbit will appear to be in the same position relative to a fixed point on the surface of the earth 208 at the same time each day. A geostationary orbit is a special type of geosynchronous orbit with the Earth's equator with each of an eccentricity and inclination equal to zero. Some satellites in HEO and all that are in LEO or MEO have an orbital period that is different than the length of a sidereal/solar day and are considered to be non-geosynchronous and do not remain stationary relative to a fixed position on the surface of the Earth. As used herein, a satellite in LEO has a lower orbital plane than a satellite in MEO or HEO, an MEO satellite has a higher orbital plane than a satellite in LEO, and an HEO satellite has a higher orbital plane than a satellite in LEO or MEO.

When present in the network environment 200, the first terrestrial RAN is generally configured to provide wireless communication service to the UE 206 by way of one or more terrestrial base stations, represented by the first base station 230. The first base station 230 is generally configured to relay communications between the network 208 and one or more UEs, such as the UE 206. The first base station 230 communicates signals to the UE 206 using a first downlink 234 and receives signals from the UE 206 using a first uplink 236. The first base station 230 may communicate with the UE 206 using any wireless telecommunication protocol desired by a network operator, including but not limited to 3G, 4G, 5G, 6G, 802.11x and the like. Though shown as having a beam profile providing coverage to a terrestrial coverage area 232, the first base station 230 may be configured to utilize a plurality of individual beams to communicate with multiple different areas at or near the same time; that is, the first base station 230 is configured to wirelessly communicate with a UE in the terrestrial coverage area 232, though it may not transmit signals to every portion of the terrestrial coverage area 232 at any given time. Similarly, though the first downlink 234 and the first uplink 236 are illustrated singularly, the UE 206 may utilize multiple downlinks and/or multiple uplinks to communicate with the first base station 230, using any one or more frequencies as desired by a mobile network operator.

Regardless of whether the network environment 200 comprises the satellite RAN, the first terrestrial RAN, or both, the network environment 200 comprises the second terrestrial RAN. The second terrestrial RAN is generally configured to provide wireless communication service to the UE 206 by way of one or more terrestrial base stations, represented by the second base station 240. The second base station 240 is generally configured to relay communications between the network 208 and/or another dedicated network (not illustrated) and one or more UEs, such as the UE 206. The second base station 240 communicates signals to the UE 206 using a second downlink 244 and receives signals from the UE 206 using a second uplink 246. The second base station 240 may communicate with the UE 206 using any wireless telecommunication protocol desired by a network operator, including but not limited to 3G, 4G, 5G, 6G, 802.11x and the like. Though shown as having a beam profile providing coverage to a second terrestrial coverage area 242, the second base station 240 may be configured to utilize a plurality of individual beams to communicate with multiple different areas at or near the same time; that is, the second base station 240 is configured to wirelessly communicate with a UE in the second coverage area 242, though it may not transmit signals to every portion of the second coverage area 242 at any given time. Similarly, though the first downlink 234 and the first uplink 236 are illustrated singularly, the UE 206 may utilize multiple downlinks and/or multiple uplinks to communicate with the first base station 230, using any one or more frequencies as desired by a mobile network operator.

For the purposes of the present disclosure, the first terrestrial RAN and the satellite RAN are considered to be public networks; whereas, the second terrestrial RAN is a private network. As used herein, a public RAN, such as the first terrestrial RAN, is owned and operated by a traditional telecommunications company or mobile network operator (MNO), such as T-Mobile, and is available to the general public. In contrast, a private RAN, as used herein, is owned/managed/operated by an enterprise, organization, or specialized service provider, is restricted to authorized users associated with the enterprise, organization, or said provider, and is tailored to the specific needs of an owner. Private RANs may be deployed at a workplace (e.g., a warehouse, storage facility, terminal, factory) or at an event (e.g., a sporting event or concert), and may be fixed or temporary/mobile. Whereas public RANs are configured to serve large numbers of subscribers using numerous base stations spread across vast territory, private RANs are configured to serve fewer users using a limited number of base stations (as few as one) and are limited to finite areas (e.g., a park, building, stadium, and the like). In general, public RANs utilize licensed spectrum, which refers to specific radio frequencies that are assigned by regulatory authorities to public telecommunication operators for exclusive use in delivering wireless communication services in a geographic area. In contrast, private RANs may use unlicensed spectrum, which refers to radio frequencies that are available for use by anyone, including private network operators, without the need for a license, but are subject to regulatory rules that manage power limits and interference to ensure shared access among multiple users. Traditionally, private RANs or private network operators used unlicensed spectrum; however, because the frequency range of the unlicensed spectrum is relatively limited, inter-network interference and frequency re-use is a significant problem.

Modern and future deployments of private RANs will increasingly utilize relationships with public networks in order to use access the public network operators'licensed spectrum and technologies. When a private RAN, such as the second terrestrial RAN of the network environment 200, utilizes licensed frequencies that at least partially overlap with the frequencies used by the public RAN (i.e., the satellite RAN or the first terrestrial RAN) of network environment 200, the resultant inter-cell interference is likely to cause disruption to UEs that intend to connect to the private RAN and UEs that intend to connect to the public RAN. While public RAN operators have the ability to modify transmission characteristics of base stations on their networks (e.g., the first base station 230), they often have no control over the transmission characteristics of base stations of private RAN operators (e.g., the second base station 240), even if the private RAN operator is using the public RAN operator's licensed spectrum. The present disclosure is directed to mitigating the inter-cell interference caused by private and public RAN frequency re-use.

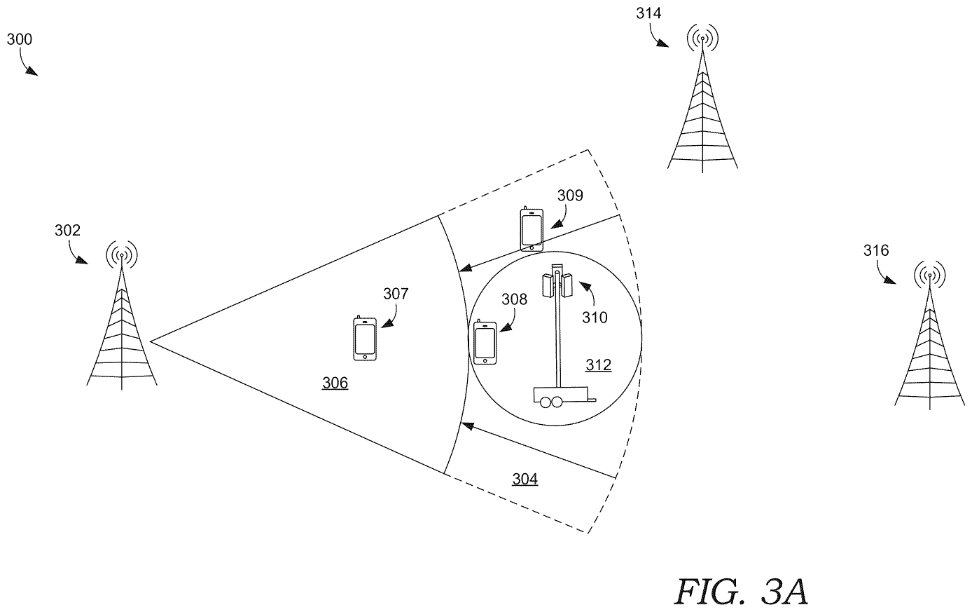

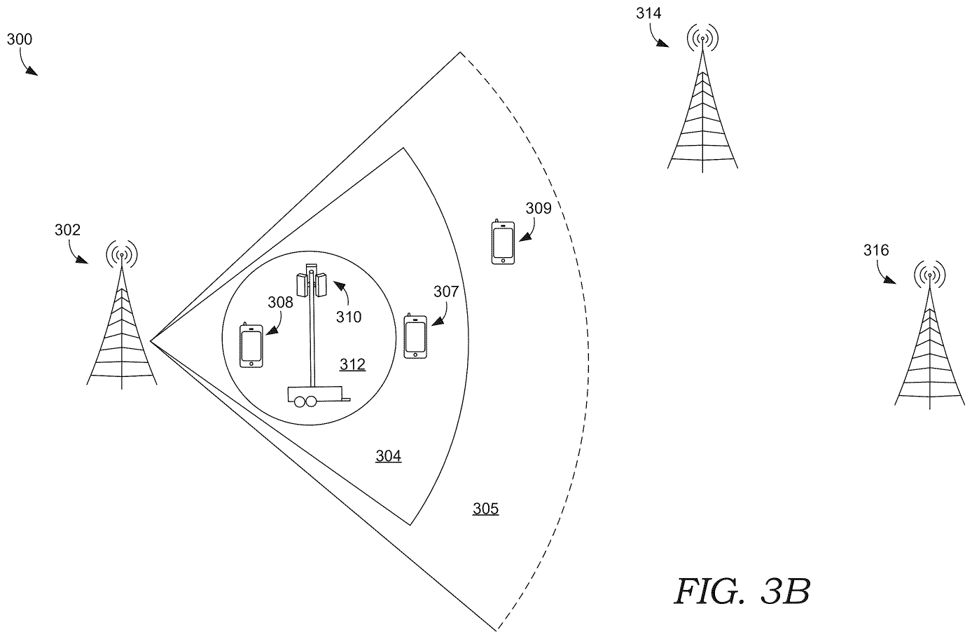

Turning now to FIGS. 3A-3B, a simplified network environment 300 illustrates aspects of the present disclosure. The network environment 300 comprises a plurality of base stations of a public RAN, such as the first terrestrial RAN of the network environment 200 of FIG. 2. The plurality of base stations of the public RAN, further referred to as public base stations, comprises a first base station 302, a second base station 314, and a third base station 316. Each of the first base station 302, the second base station 314, and the third base station 316 may have any one or more features or attributes of the first terrestrial base station 230 of FIG. 2. The network environment 300 further comprises a private base station 310, associated with a private RAN, as described with respect to FIG. 2. The network environment 300 comprises a plurality of UEs for the purposes of illustrating certain aspects of the present disclosure, including a first UE 307, a second UE 308, and a third UE 309; however, it is not necessary for more than one UE to be present in the network environment 300. Each of said UEs may have any one or more features of the 206 of FIG. 2. In each of FIGS. 3A and 3B, the first base station 302 has an initial (or default) coverage area prior to implementing a mitigation procedure; said initial coverage area is referred to herein as a first coverage area 304. The private base station 310 has a private coverage area 312. With reference to FIG. 3A, the first base station 302 has a second coverage 306 after the mitigation procedure is implemented; with reference to FIG. 3B, the first base station 302 has a third coverage area 305 after implementing the mitigation procedure.

Continuing with reference to FIG. 3A, the network environment 300 illustrates a first aspect of the present disclosure, in which the private base station 310 and its private coverage area 312 is within a predetermined threshold distance of a cell edge of the first coverage area 304 of the first base station 302. Though shown as being wholly disposed within the first coverage area 304, the private coverage area may alternatively at least partially overlap with the first coverage area within the predetermined threshold distance of the cell edge of the first coverage area 304. In other words, the boundary of the private coverage area 312 nearest to the first base station 302 is within a threshold distance of the cell edge of the first coverage area 304; because of this, there is a relatively limited amount of inter-cell interference (limited overlapping coverage areas) between the first coverage area 304 and the private coverage area 312. In the illustrated aspect, each of the second UE 308 and the third UE 309 may experience undesirable levels of signal degradation - regardless of which RAN said UEs are attempting to connect to.

In one illustrative hypothetical, if the first UE 307 and the third UE 309 are not authorized to connect to the private base station 310, so each will attach to the first base station 302; if the second UE 308 is configured to connect to the private base station 310 then it will attempt to connect thereto. Initially, it is possible that the second UE 308 may have difficulty connecting to the private base station 308 based on the inter-cell interference caused by the first base station 302 when transmitting to the first coverage area 304. Even if the second UE 308 can connect to the private base station 310, it is likely that the second UE 308 will experience a particularly degraded connection. The third UE 309 may also experience a moderately degraded connection due to its proximity to the cell edge of the private coverage area 312. In order to cure the degradation of the connections for the second UE 308 and the third UE 309, a networked computing component may determine that a private base station is operating in or near the first coverage area 304 based on at least one of the first UE 307 and the third UE 309 reporting a threshold amount of degradation to one or more key performance indicators (KPIs) of their connections with the first base station 302. In other aspects, a measurement report from the second UE 208 may be provided to the operator of the first base station 302 that indicates one or more KPIs of signaling from the first base station 302 and/or the private base station 312 are below a predetermined threshold or have degraded more than a threshold amount. The determination that KPI degradation is attributable to the operation of a private base station may be further based on a determination that KPI degradation is occurring on one band (e.g., band 41) or frequency range but not another (e.g., band 71); additionally or alternatively, the attribution determination may be based on a determination that the KPI degradation is sudden (i.e., not a gradual degradation that might be attributable to other noise). The one or more KPIs may comprise a signal quality metric (e.g., a reference signal received quality (RSRQ) or other measurement that quantifies the quality of a received reference signal relative to the received signal strength), a noise metric (e.g., a signal to interference plus noise ratio (SINR), a signal to noise ratio (SNR), an error vector magnitude (EVM), a channel quality indicator (CQI), a noise figure (NF), and the like).

Once said degradation is reported by one or more UEs and attributable to the operation of a private base station, the networked computing component may query a data repository in order to determine which private base station is creating an inter-cell interference condition. The query may comprise a lookup on a networked storage device (e.g., an operational support system (OSS), service management and orchestration function (SMO), network data analytics function (NWDAF), RAN intelligent controller (RIC), cloud-native solutions, and the like) to identify private base stations or private RANs operating in the vicinity of the first base station 302. A single query or a multi-query process will return a location of the private base station 310 and/or its associated private coverage area 312. The private base station 310 is positively identified as the private base station causing inter-cell interference based on the return of the query (or subsequent determination based on transmission characteristics of the private base station 310 if coverage area data is not included in the query response) indicating that the private coverage area 312 at least partially overlaps with the first coverage area 304. If the networked computing component determines that said overlap is within the predetermined distance of the cell edge of the first coverage area 304 (limiting inter-cell interference for both base stations to their cell edge regions), then the first base station 302 will execute a mitigating procedure to prevent downlink signals from the first base station 302 from reaching the private coverage area 312 and causing inter-cell interference.

In the aspect illustrated in FIG. 3A, the mitigating procedure may take the form of reducing the transmission power of the signals transmitted from the first base station 302, reducing its corresponding coverage area from the first coverage area 304 to the second coverage area 306. In aspects where a UE, such as the third UE 309, is no longer covered by the first base station 302 following a transmission power reduction, another base station, such as the second base station 314 or the third base station 316, may increase its transmission power in order to provide coverage for the third UE 309. The mitigating procedure may alternatively take the form of a carve out to the first coverage area 304 using beamforming; that is, the first base station 302 may continue to communicate to portions of the first coverage area 304 that lie beyond the second coverage area 306 but avoid the private coverage area 312. Using said mitigating procedure, the third UE 309 may continue to be served by the first base station 302 without any cascading modifications to the coverage areas of neighboring base stations (e.g., the second base station 314 or the third base station 316). Said beamforming at the first base station 302 may take the form of using codebook subset restrictions as part of codebook beamforming, or it may take the form of using other beamforming techniques to avoid transmitting signals at powers and vectors that would enter the private coverage area 312.

Turning now to FIG. 3B, an alternate hypothetical deployment of the first base station 302 and the private base station 310 is illustrated that triggers different mitigating procedures. In response to the query described in FIG. 3A, it may be determined that the portion of the private coverage area 312 extends nearer to the first base station 302 than the predetermined threshold (e.g., the private coverage area 312 extends in to the first coverage area 304 more than 10% of the cell radius of the first coverage area 304). Though illustrated as the private base station 310 being disposed wholly within the first coverage area 304, one skilled in the art will appreciate that the private base station 310 may be disposed beyond the first coverage area 304 and just propagate far enough into the first coverage area 304 to extend beyond the predetermined threshold. In such a hypothetical, the mitigating procedure may take the form of deactivating a cell of the first base station 302 associated with the first coverage area 304 and the inter-cell interference. In other words, if the cell associated with the first coverage area 304 and a cell associated with the private coverage area 312 both use band 41 and the private coverage area 312 extends greater than threshold distance past the cell edge of the first coverage area 304 towards the first base station 302, then the cell associated with the first coverage area 304 will be deactivated (no signals will be transmitted by the first base station 302 on band 41 to the first coverage area 304). In some aspects, the first base station 302 may already be transmitting to a second coverage area 305 using a different range of frequencies (e.g., band 71); if the second coverage area 305 wholly comprises the first coverage area then UEs such as the first UE 307 and the third UE 309 will continue to be served by the first base station 302 (even if they are out of reach of the neighboring second base station 314 and third base station 316). In other aspects, such as when the first base station is not transmitting on a different frequency to at least a portion of the first coverage area 304 or wherein the second coverage area 305 contains only a portion of the first coverage area 304, the first base station 302 will energize a second cell using a different set of frequencies than the deactivated cell or modify the transmission profile of the second cell (e.g., modifying physical antenna tilting, physically changing the boresight azimuth of the antenna, and/or beamforming) to cause the second coverage area 305 to wholly comprise the first coverage area 304.

In the hypotheticals described in FIGS. 3A-3B, the one or more implemented mitigation procedures may be reversed in order to return normal service to the first coverage area 304 in the event that deployment of the private base station 310 was temporary. In a first aspect, at a time after the mitigating procedure(s) was implemented, a UE in the first coverage area that was previously served by the private base station 310 (e.g., the second UE 308) may report one or more KPIs are worse than a recovery threshold (e.g., poor reference signal strength of the best available base station) once the private base station 310 is deactivated. In such a responsive aspect, the one or more networked computer processing components that were responsible for detecting and mitigating the inter-cell interference conditions described herein may query the networked data repository, determine the private base station 310 is no longer operational, and instruct the first base station to undo its mitigation procedure(s), returning the first base station to its pre-mitigation operations. In other aspects, during the query to identify the private base station 310 and determine its associated private coverage area 312, the one or more networked computer processing components may also query to determine an operational end date of the private base station 310. In response to determining an operational end date, a restoration timer can be implemented that automatically restores the first base station 302 to its pre-mitigation operations upon reaching the operational end date of the private base station 310.

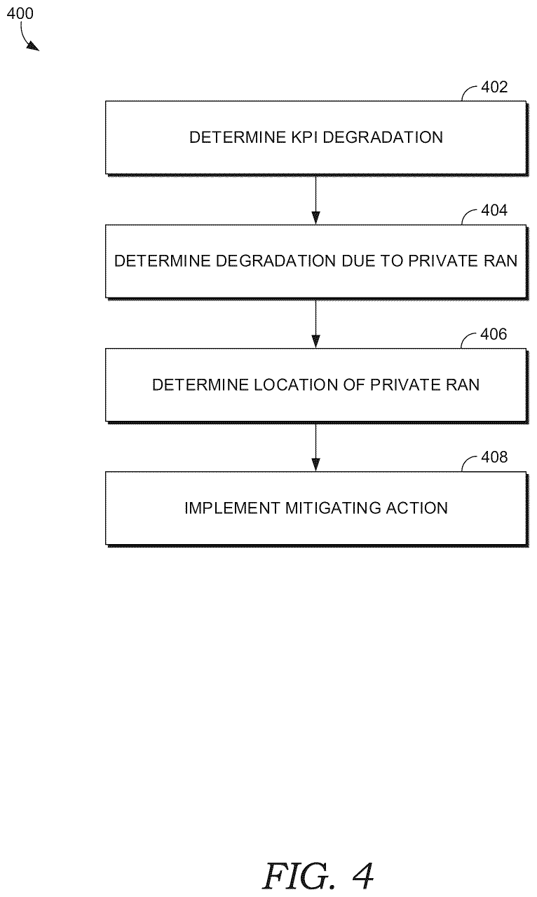

Turning now to FIG. 4, a flow chart representing a method 400 is provided. Generally, the method 400 mitigates inter-cell interference between a first RAN having a first PLMN and a second RAN having a second PLMN, as described with respect to FIGS. 2-3B. At a first step 402, degradation to one or more key performance indicators (KPIs) of a radio link is determined, according to any one or aspects described herein. At a second step 404, it is determined that the KPI degradation of step 402 is due to inter-cell interference between a cell of the first RAN and a cell of the second RAN, according to any one or more aspects described herein. At a third step 406, a location and coverage area associated with the second RAN is determined in order to determine which mitigation procedure should be performed, according to any one or more aspects described herein. At a fourth step 408, one or more mitigating procedures are implemented based on the location and coverage of the second RAN with respect to the coverage area of the first RAN (determined in step 406), according to any one or more aspects described herein.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A system for mitigating inter-cell interference, the system comprising:
a base station of a first radio access network (RAN) configured to wirelessly communicate with a user equipment (UE) in a first coverage area; and
one or more computer processing components configured to perform operations comprising:
determine a degradation in one or more key performance indicators (KPIs) of wireless telecommunication signals of a cell of the base station;
determine the degradation is caused by an operation of a second RAN, the second RAN being different than the first RAN;
determine a second coverage area of the second RAN at least partially overlaps with the first coverage area; and
implement a mitigation action based on said determinations.

2. The system of claim 1, wherein the first RAN is a public RAN.

3. The system of claim 2, wherein the degradation is based on at least one measurement report from at least one UE in the first coverage area.

4. The system of claim 3, wherein the one or more KPIs comprises a signal to interference noise ratio (SINR).

5. The system of claim 3, wherein, the second RAN is a private RAN.

6. The system of claim 5, wherein determining the second coverage area at least partially overlaps with the first coverage area is based on a query of a data repository, and wherein the query indicates a boundary of the second coverage area.

7. The system of claim 6, wherein determining the degradation is caused by the operation of the second RAN is based on the determination that the second coverage area at least partially overlaps with the first coverage area and that a set of frequencies used by the second RAN to wirelessly communicate with UEs in the second coverage area are within a threshold frequency distance of a first set of frequencies used by the first RAN to wirelessly communicate with UEs in the first coverage area.

8. The system of claim 7, wherein implementing the mitigation action comprises reducing a transmission power used by the base station to transmit the first set of downlink signals based on a determination that an overlapping portion of the second coverage area extends less than a threshold distance towards the base station from the cell edge of the base station.

9. The system of claim 7, wherein implementing the mitigation action comprises disabling a cell used by the base station to transmit the first set of downlink signals based on a determination that an overlapping portion of the second coverage area extends greater than a threshold distance towards the base station from the cell edge of the base station.

10. The system of claim 7, wherein implementing the mitigation action comprises modifying a transmission profile used by the base station to transmit the first set of downlink signals based on a determination that an overlapping portion of the second coverage area extends less than a threshold distance towards the first base station from the cell edge of the first base station.

11. The system of claim 7, wherein the operations further comprise ending the mitigation action in response to an indication from one or more UEs that one or more KPIs in the second coverage area are below a recovery threshold.

12. The system of claim 7, wherein the operations further comprise ending the mitigation action in response to expiration of a recovery timer, the recovery timer being set in response to the query and configured to expire concurrent with a conclusion of the second RAN's operation.

13. A method for mitigating inter-cell interference, the method comprising:
determine, based on a degradation of one or more key performance indicators (KPIs) of wireless telecommunication signals of a cell of a first base station, that an inter-cell interference condition exists between the first base station and a second base station;
determine, based on a query to a networked data repository, that the second base station is associated with a second RAN, the second RAN being different than a first RAN associated with the first base station;
determine, based on the query, a second coverage area associated with the second base station;
determine, based on an amount of overlap of the first coverage area and the second coverage area, a mitigation action; and
implement the mitigation action at the first base station, wherein the mitigation action modifies wireless signal propagation by the first base station.

14. The method of claim 13, wherein the mitigation action comprises reducing a transmission power used by the first base station to transmit a set of downlink signals based on a determination that an overlapping portion of the second coverage area extends less than a threshold distance towards the first base station from the cell edge of the first base station.

15. The method of claim 13, wherein implementing the mitigation action comprises disabling a cell used by the first base station to transmit a set of downlink signals based on a determination that an overlapping portion of the second coverage area extends greater than a threshold distance towards the first base station from the cell edge of the first base station.

16. The method of claim 13, wherein implementing the mitigation action comprises modifying a transmission profile used by the first base station to transmit a set of downlink signals based on a determination that an overlapping portion of the second coverage area extends less than a threshold distance towards the first base station from the cell edge of the first base station.

17. A non-transitory computer readable media with instructions thereon that, when executed by one or more computer processing components, cause the one or more computer processing components to perform operations for mitigating inter-cell interference, the operations comprising:
determine, based on a degradation of one or more key performance indicators (KPIs) of wireless telecommunication signals of a cell of a first base station, that an inter-cell interference condition exists between the first base station and a second base station;
determine, based on a query to a networked data repository, that the second base station is associated with a second RAN, the second RAN being different than a first RAN associated with the first base station;
determine, based on the query, a second coverage area associated with the second base station;
determine, based on an amount of overlap of the first coverage area and the second coverage area, a mitigation action; and
implement the mitigation action at the first base station, wherein the mitigation action modifies wireless signal propagation by the first base station.

18. The non-transitory computer readable media of claim 17, wherein the mitigation action comprises reducing a transmission power used by the first base station to transmit a set of downlink signals based on a determination that an overlapping portion of the second coverage area extends less than a threshold distance towards the first base station from the cell edge of the first base station.

19. The non-transitory computer readable media of claim 17, wherein implementing the mitigation action comprises disabling a cell used by the first base station to transmit a set of downlink signals based on a determination that an overlapping portion of the second coverage area extends greater than a threshold distance towards the first base station from the cell edge of the first base station.

20. The non-transitory computer readable media of claim 17, wherein implementing the mitigation action comprises modifying a transmission profile used by the first base station to transmit a set of downlink signals based on a determination that an overlapping portion of the second coverage area extends less than a threshold distance towards the first base station from the cell edge of the first base station.
